(19) United States
(12) Patent Application Publication
(10) Pub. No.: US 2026/0222367 A1
(43) Pub. Date: Jul. 30, 2026

(54) HUMAN-INSPIRED MEMORY MANAGEMENT AND RESPONSE GENERATION

(71) Applicant: HEWLETT PACKARD ENTERPRISE DEVELOPMENT LP, Spring, TX (US)

(72) Inventors: Sidhant Arora, Spring, TX (US); Ian Matthews, Galway (IE); Mark Perreira, Sunnyvale, CA (US); Pon Arasu Neranj Subramanian, Spring, TX (US); Umang Kedia, Spring, TX (US)

(21) Appl. No.: 19/040,484

(22) Filed: Jan. 29, 2025

(51) Int. Cl. H04L 51/02; G06F 40/284; H04L 51/04

(52) U.S. Cl. CPC H04L 51/02; G06F 40/284; H04L 51/04

(57) ABSTRACT

Systems and methods are provided for emulating human memory in the form of short-term memory (STM) and long-term memory (LTM) stores to which aspects of a chatbot conversation may be stored, and from which ST and LT memories may be retrieved based on relevance to the chatbot conversation and recency of access of ST memories. Contextual information relevant to the chatbot conversation may also be retrieved. A response to a query or input presented during the chatbot conversation can be generated using the retrieved ST/LT memories, the contextual information, and emotional tone of the chatbot conversation. The chatbot conversation itself can be stored as a memory(ies), and weights of memories, e.g., ST memories, can be adjusted to emulate human forgetfulness and remembrance.

### BACKGROUND

Large language models (LLMs) are computational models capable of language generation or other natural language processing tasks. As language models, LLMs acquire these abilities by learning statistical relationships from vast amounts of input data, such as text, during training. LLMs can provide predictive power regarding syntax, semantics, and ontologies contained in human language.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1A illustrates an example system for a conversational response system based on human-inspired memory management in accordance with examples of the disclosed technology.

FIG. 1B illustrates an example architecture of a memory management server in accordance with examples of the disclosed technology.

FIG. 1C illustrates an example architecture of a response generation system in accordance with examples of the disclosed technology.

FIG. 2 is a flow chart illustrating example operations for effectuating human-inspired memory management and resulting response generation in accordance with examples of the disclosed technology.

FIG. 3 depicts an example computing component that may be used to determine emotional context in accordance with examples of the disclosed technology.

FIG. 4 depicts an example computing component that may be used to effectuate response generation in accordance with examples of the disclosed technology.

FIG. 5 depicts an example computing component that may be used to effectuate improved (human-inspired) memory management and query/conversational response generation in accordance with examples of the disclosed technology.

FIG. 6 is a computing system that may be used to implement aspects of the disclosed technology.

The figures are not exhaustive and do not limit the present disclosure to the precise form disclosed.

### DETAILED DESCRIPTION

As noted above, LLMs can provide predictive power regarding syntax, semantics, and ontologies contained in human language. Effective memory management for LLMs is an important consideration in order for such LLMs to function as conversational agents capable of maintaining coherent, contextual dialog. Current approaches to memory management typically involve storing previous chat histories as part of a prompt sent to an LLM (on which the LLM's response can be based). While various memory types and libraries offer potential solutions, there exists a significant gap with respect to how these memory systems are designed. Existing solutions primarily adopt an engineering-centric perspective, thereby failing to leverage insights from how human memory operates.

LLMs, inspired by the architecture of the human brain, comprise interconnected layers akin to neurons with activation functions triggered based on defined thresholds. As such, there is an opportunity to develop a more human-centric approach to memory management in LLMs, drawing upon principles of how the human brain processes and retains information.

Accordingly, examples of the disclosed technology provide systems and methods of implementing and incorporating a neurobiologically-informed memory management system for LLMs. By emulating the mechanisms underlying human memory formation, storage, and retrieval, examples of the disclosed technology are able to enhance the conversational capabilities of LLMs, enabling them to maintain more natural, context-aware dialogs akin to human interactions. As such, it should be understood that examples of the disclosed technology provide a computer-based/computerized solution to the computer-based problem of better emulating human responses/conversation through a computer interface, e.g., that of an LLM user interface (UI), chatbot, or similar application. Examples of the disclosed technology, as will be described in greater detail below, leverage storage mechanisms that emulate human short-term and long-term memory. An LLM may utilize such short-term memory (STM) and long-term memory (LTM) to generate more human-like and better-contextualized/more coherent responses and conversations, in real-time, despite not involving the human mind/memory/thinking.

More particularly, examples of the disclosed technology may comprise a dual system approach. A first system can address memory storage and retrieval, as well as decay, across both STM and LTM. Memories stored in STM/LTM can be weighted, emotions can be analyzed, and adaptive memory decay can be used to simulate human memory access, including forgetfulness and recollection. It should be understood that memories in the context of the disclosed technology refer to retained, topical data or information on which the generation of conversational responses may be based. Such data would be memories if the data/information was retained by the human mind. Emotions may be mood, feeling, or “state of mind” characterizations of such data/information.

A second system may be used for actual response generation, and can be implemented using an LLM augmented by Retrieval-Augmented Generation (RAG). A RAG system can generate responses in a conversation based on relevant memories provided by the first system, where, as noted above, the relevancy of memories can be determined through dynamic weighting, emotional context, and memory decay. For example, a query, or initiated conversation can be parsed, relevant information can be accessed to provide additional/more context to the query/conversation, and relevant memories can be combined to guide response generation by an LLM. Moreover, any newly acquired knowledge or a new conversational turn can be fed back to the first system to potentially be stored in STM or LTM.

The integration of the first and second systems allows for a conversational model/system to dynamically adapt memory recall and emotional tone to deliver contextually appropriate responses. This emulation of human memory where, e.g., certain facts or information may be more/less important, and thus, remembered differently (forgotten sooner or remembered longer), can effectuate a more human-like conversation. That is, a conversation will appear to be more human-like because generated responses will be based on memories that have been stored like they would be in the human mind. For example, responses can tend to be less formulaic/static and more natural, e.g., responses may exhibit focus on more emotionally-significant aspects of a conversation, while being less focused on conversational aspects that would likely be forgotten after some period of time.

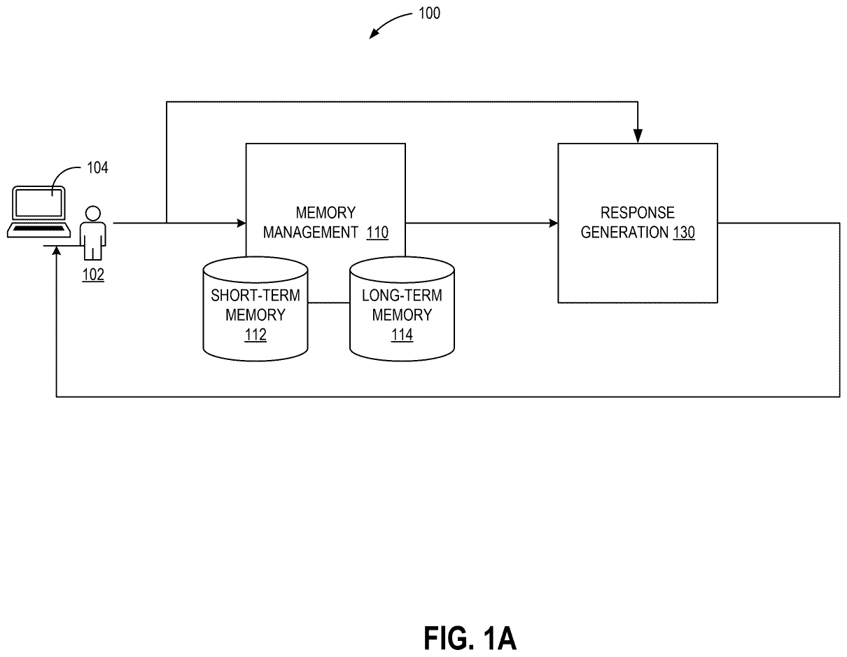

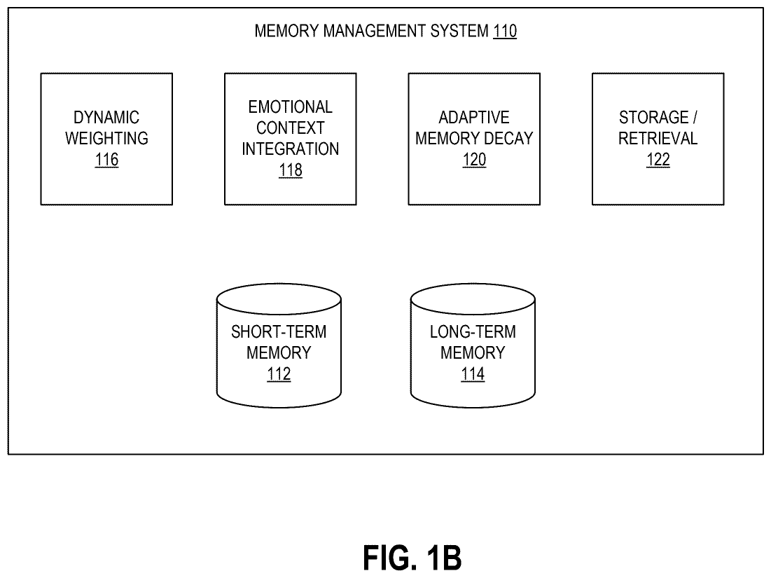

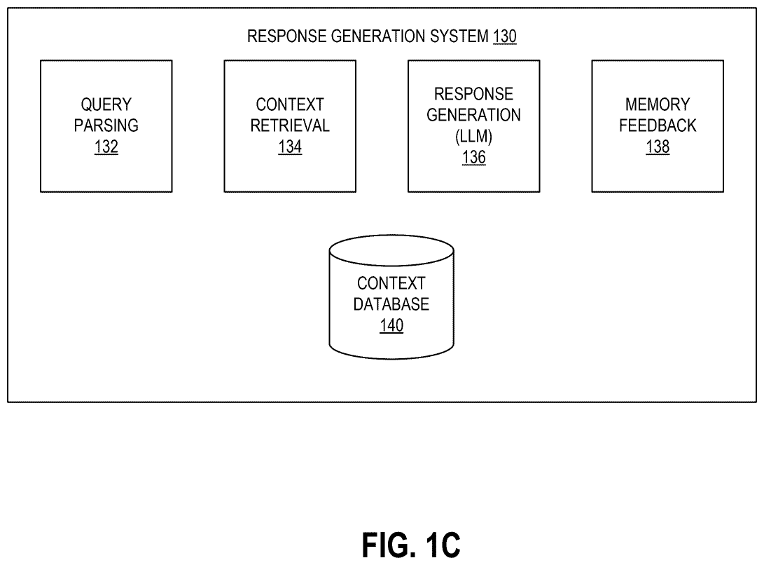

FIG. 1A illustrates a system 100, which may be a human-inspired memory management and response generation system in accordance with examples of the disclosed technology. As illustrated in FIG. 1A, a user 102 may interact with a conversational system 104, e.g., a generative AI application or interface, or other similar system, such as a chatbot (examples of which include ChatGPT, Copilot, Gemini, LLAMA, and the like). Such chatbots are computing systems designed to simulate a human. More specifically, chatbots are software running on hardware configured to engage in communications with humans or other computing systems or devices, attempting to behave similarly to a human.

In some examples, conversational system 104 can refer to computer readable code or instructions that, when executed by a processor, simulates an interaction with a human. Conversational system 104 can act as a technical support representative, a concierge, a purchasing agent, etc., and communicate with a user, such as user 102. The conversational system 104 can include back and forth communications with user 102 as well as other users via computing devices, during a chatbot session.

As noted above, examples of the disclosed technology improve upon conventional conversational systems by emulating (or better emulating) human memory as a basis for generating conversational responses, which includes both STM and LTM. By some standards STM refers to an ability to hold a (typically) small amount of information in an active state for a short amount of time, e.g. plus-or-minus four items of information for some time on the order of seconds. On the other hand, LTM is generally considered to refer to holding informative knowledge indefinitely. Typically, LTM is associated with larger capacity than that of STM. Accordingly, a memory management system 110 (which can be embodied as a server) may handle the storage of, retrieving/accessing, and applying memory decay to information/data gleaned by conversational system 104 (to emulate STM). Memory management system 110 may further handle the storage and handling of compressed or encoded representations of information, such as an overall conversation engaged in by user 102 at or through conversational system 104. This representation of information can be likened to LTM. As will be discussed in greater detail below, dynamic weighting, emotional context integration, and adaptive memory decay mechanisms or operations can be used to characterize and store information as short term memories in STM, e.g., STM 112, and as long term memories in LTM, e.g., LTM 114, where STM and LTM can be embodied as data stores or databases.

Response generation system 130, based on the characterization of information gleaned from and during a conversation involving user 102 at conversational system 104 (as well as other obtained information), may generate responses to queries or other statements made or input by user 102 to effectuate a conversation with user 102. As will also be described in greater detail below, response generation system 130 may comprise an LLM that is augmented by RAG. As is understood by those of ordinary skill in the art, RAG can refer to an approach for obtaining data as context for LLMs to improve the relevancy of responses or information generated by the LLM. Such responses may be fed to or transmitted back to conversational system 104 for consumption by user 102.

STM 112 may store the most recent conversational turns (e.g., the last five to ten utterances) in their original form (text or multimodal input). STM 112 may provide a window of immediate context for memory retrieval (by memory management system 110) and response generation (by response generation system 130). Information in STM 112 decays over time or is replaced by newer conversational turns. It should be understood that the term “conversational turn,” can refer to an interactive sequence comprising an input from the user, followed by an output, and then another input from the user. This sequence captures the interaction between user 102 and conversational system 104, allowing for the analyzing of how conversational system 104's responses influence user 102's subsequent inputs.

LTM 114 stores a compressed or encoded representation of the overall conversation history. This storing of conversational history representations can be implemented using various techniques. One such technique may comprise the summarization of conversational topics and entities. Another technique may be the encoding of conversational context into dense vector representations. Still another technique may involve implementing or creating a knowledge graph or database of conversational facts and relationships. Ultimately, LTM 114 can provide a more condensed and persistent representation of a conversation that can be referenced by system 100.

FIG. 1B illustrates a more detailed representation of memory management system 110, which, in addition to STM 112 and LTM 114, may include a dynamic weighting component 116, an emotional context integration component 118, and an adaptive memory decay component 120.

Memory management system 110 may be an embodiment of the aforementioned “first system,” and handles memory storage, retrieval, and decay across STM 112 and LTM 114. STM 112, as noted above, may comprise a database, such as a Redis database, for storing short term memories, and can utilize a storage/retrieval mechanism 122 to retrieve memories. Storage/retrieval mechanism 122 may be embodied as a Redisearch engine for optimized retrieval of such short-term memories via approximate nearest neighbor (ANN) searching. LTM 114 may comprise another database, such as a vector database, examples of which are the Pinecone vector database or the Any Vector database for storing summarized memory vectors. In some examples the long term memories stored in LTM 114 may be daily summaries of information gleaned from a conversation. It should be understood that the implementations of STM 112 and LTM 114 can vary. However, Redis (REmote DIctionay Service) as the storage/retrieval mechanism 122, refers to an open-source in-memory database that is a key-value store that stores data in memory, allowing for fast storage and retrieval. Because STM 112 stores data as short term memories that over time can decay and be “forgotten,” removed from storage, traditional, full-featured databases are not needed for STM. For LTM 114, the use of a vector database is advantageous given that vector databases, through the use of vector embeddings (numerical representations of data), are able to capture the meaning and context of data, and facilitate similarity searching. This is appropriate for long term memories that comprise summaries of data or information, i.e., the meaning/context of the information is not lost despite being stored in a summarized version or format.

A dynamic weighting system or component (DWS) 116 assigns and continuously updates weights associated with memories using a neural network. The weight(s) associated with data or information comprising memories can be adjusted based on recency, relevance, emotional significance, and access frequency. For example, more recent memories or data/information, can be associated with or assigned higher weights than those memories that are less recent. Relevance of a memory can be determined through ANN searching in Redisearch to identify memories that are closest, e.g., most related or relevant to the current conversation. As noted above, memory retrieval can be effectuated through the use of storage/retrieval mechanism 122, e.g., Redis and Redisearch, where Redis refers to one type of contemplated database, and Redisearch refers to a search engine that can be used to query a Redis database. In terms of emotional significance, memories tagged with stronger emotional content are assigned higher weights. The detection or determination of an emotion(s) associated with a memory is described in greater detail below. The more frequently a memory is accessed, the higher the weight that is assigned to that memory. A neural network can be leveraged to adjust weights for memories in real-time. The neural network can assign weights in real-time based on memory-usage context and interactions between the user and conversational system 104. In some examples, the neural network can be a regression-based model that assigns weights to memories in real-time. The neural network may consider various factors, such as the time of creation, emotional tags, frequency of access or matches with a current user query, most recent access time, and other parameters defined by memory management system 110. Additionally, the neural network can incorporate real-time user feedback on the relevance and usefulness of a memory(ies) used in responses. This approach can ensure that memories with stronger emotional significance and higher relevance are prioritized appropriately. In some examples, a rule-based system can be used instead of a neural network depending on the complexity/requirements of the context/application in which the examples are used. For example, a rules-based system could use defined rules to assign weights, whereas the neural network can learn and adjust weights dynamically based, again, on user/conversational system 104 interactions, and context.

Emotional Context Integration (ECI) component 118 analyzes emotions associated with data or information that arises in a conversation between user 102 and conversational system 104. This can be performed at each conversational turn. It should be noted that this focus on conversational turns rather than detecting emotion on a “per-input” basis allows for a better understand of the dynamics of an interaction. By analyzing the interaction from a conversational turn perspective, the context of the user's query, the system's response, and the user's reaction to that response can be better captured or understood. This holistic view helps in improving the system's response generation by considering the flow of a conversation rather than isolated inputs. It should also be noted that a memory can be tagged with multiple emotions to provide a more accurate reflection of a user's emotional state, thereby making response generation more empathetic or contextually appropriate.

Upon determining the emotion(s) associated with a memory, the memory can be appropriately tagged or associated with that emotion(s). By tagging or associating memories with emotions, the retrieval of the memories via storage/retrieval mechanism 122 can be influenced, as well as the tone of a response to a conversational input. In particular, a natural language processing (NLP) model(s) can be used to detect emotions in a user's input. Emotions can then be stored with or alongside memories to effectuate contextual recall, where a current emotional state associated with some user input influences the retrieval of some memory(ies) to match the tone (emotional context) of the conversation at a current time. Moreover, the emotional context can be used as a basis for adjusting the tone of the response. For example, based on input from user 102, an NLP model can determine that the words/phrases input by user 102 suggest sadness. The words/phrases are stored as memories in STM 112, for example, along with a “sad” emotional tag. Given this determination, a response can be generated which matches the sad emotion by retrieving, e.g., data representative of a memory that is also associated with/stored with a sad emotional tag. Thus, the tone of the conversation is determined, and a response can be generated which has the same tone. This can prevent the generation of response that is inappropriate in tone, e.g., a “happy” response to a “sad” conversational input. That said, examples of the disclosed technology are not merely limited to matching emotions or tones, but can determine an appropriate response to conversational input by looking to the context of the conversational input. For example, while the tone of conversational input may be “sad,” words/phrases may be determined to reflect a desire of user 102 to be uplifted, and so an appropriate response need not necessarily be a sad response.

Adaptive Memory Decay (AMD) component 120 (in some examples, a rule-based mechanism) can be used to apply a non-linear decay function to simulate human forgetfulness, with mechanisms for reactivation and reconsolidation upon memory access. Decay rate can be influenced by a variety of factors, including, e.g., emotional intensity, retrieval frequency, and contextual importance associated with a memory. Thus, memory management system 110 can assign a determined decay rate to a memory, i.e., a time value representative of how long that particular memory should remain in, e.g., STM 112. This can be accomplished via application of a non-linear/exponential decay function that reduces a memory's weight based on the elapsed time since it was last accessed. This decay rate can be controlled by a user-defined parameter referred to as a decay clock, which determines how quickly the decay occurs. Memories that are accessed frequently are reactivated by resetting their timestamp and incrementing their access count, reinforcing their relevance and slowing their decay. This ensures that important and frequently-recalled memories remain active in the system, while less relevant memories gradually diminish in importance. The process is efficient and deterministic, relying on predefined rules rather than machine learning models.

AMD component 120 may also implement memory reactivation, where the accessing of a memory from STM 112 can reset its decay rate, and can, in some examples, result in the strengthening of its connection to related memories. In some examples, the storage of the memory can also be impacted by decay, where memory access can be based on recent retrieval, emotion, and time pursuant to a memory's assigned weight.

In operation, memory management system 110 ingests words, phrases, sentences, or other textual (or verbal) input during a conversational turn from user 102. As noted above, emotional context integration component 118 may determine an emotional context of the input from user 102, and tag or associate emotions with the input from user 102. Upon determining the emotional context of the input, memory management system 110 can initialize a memory (i.e., the analyzed input) with its relevant attributes, including its emotional context tag, the time of its storage (timestamp), its access count (if an original or not-yet-stored memory, its access count is zero), and an initial or default weight. As a conversation proceeds, dynamic weighting system 116 can dynamically adjust this weight based on the aforementioned factors of recency, relevance, emotional significance, and access/retrieval frequency.

Emotional context integration component 118 may tag the input of user 102 with an appropriate emotional identifier or indicator, and may then modulate memory retrieval by instructing adaptive memory decay component 120 to increase the weight of a memory if that memory is tagged or is associated with an emotion that matches a current emotion of the input from user 102, and the context of the memory is the same as the context determined to exist in a current conversation. In this way, when response generation system 130 (discussed in greater detail below) generates a response, it can base the generated response on memories accessed, in this example, according to emotional similarity with the current emotional context of user 102's input.

As discussed above, a decay function can be applied to a memory by adaptive memory decay component 120 in order to simulate human-like forgetfulness. The decay associated with a particular memory can be reset, i.e., the memory can be reactivated if the memory is accessed. The accessing of data making up a memory stored as a short term memory, for example, can be likened to remembering, thereby, once again, becoming a recent item of short term memory. The application of decay can be effectuated through the use of a floating decay clock that can reflect some user-defined time constant that controls the decay rate. Based on the time of storage associated with a memory, the amount of time that a memory has existed (elapsed time) can be determined, where the decay rate is a function of elapsed time and the decay clock. When a memory is accessed, reactivation of that memory is effectuated, where a new timestamp (the time of access) associated with the memory is defined, and an access counter associated with the memory can be incremented which reflects the retrieval frequency of the memory.

Storage/retrieval mechanism 122 may store in STM 112, in some examples, up to 100 recent memories along with their respective vector embeddings, emotional tags, and associated weights. Based on the decay (as well as retrieval frequency and emotional context), memories in STM 112 may be updated or removed.

Each memory comprises, or is structured as follows: a portion of conversational text, i.e., the “memory;” an emotion tag; a dynamic weight; an embedding (the vector representation of the memory); and a timestamp reflecting the time of its storage (or access). When a memory is stored, it can be stored in a Redisearch index using an ANN vector field that allows for efficient approximate nearest neighbor search. When a user's query, for example, is received, its embedding is computed, and matched to recent memories based on cosine similarity. An example of a Redisearch index is as follows.

r.ft(“memories”).create_index([
TextField(“memory”),
TextField(“emotion”),
NumericField(“weight”),
NumericField(“timestamp”),
VectorField(“embedding”, “FLAT”, {“TYPE”: “FLOAT32”, “DIM”: 512,
“DISTANCE_METRIC”: “COSINE”})
])

LTM 114 may be embodied as a vector database that stores summarized daily (or other defined duration/time period) vector embeddings of conversational inputs, the date of storage, and associated emotional context as follows.

if date is None:
date = time.strftime(“%Y-%m-%d”)
summary_id = f“summary:{user_id}:{date}”
index.upsert([(summary_id, embedding, {“summary”: summary, “date”:
date})])

In terms of retrieving memories from STM 112, when a user initiates a query, for example, memory management system 110 generates an embedding of the query and performs an ANN search using Redisearch to find relevant recent memories. For example, the top N memories may be retrieved, and sorted by a cosine similarity score to facilitate fast and relevant memory recall. With respect to retrieving memories from LTM 114, daily summaries are retrieved from the vector database based on similarity to the query embedding. The query embedding can be compared to stored daily summary embeddings for high similarity scores, retrieving summaries with a close semantic match.

FIG. 1C illustrates a more detailed representation of response generation system 130, which may include a query parsing component 132, a context retrieval component 134, a response generation component 136, e.g., embodied as an LLM, a memory feedback component 138, as well as a context database 140.

Generally, response generation system 130 may comprise a Retrieval Augmented Generation (RAG)-based system that uses the relevant memories provided by memory management system 110. RAG is a technique that can be used to optimize outputs of generative AI models, such as LLMs, e.g., response generation component 136, through information retrieval capabilities. Generative AI models are generally trained on vast volumes of data and use billions of parameters to generate outputs for tasks, such as answering queries, translating languages, and completing sentences. RAG techniques augment tasks with a generative AI model by referencing a knowledge base external to the model's training data, before generating a response. This can allow the generative AI model to use domain-specific knowledge, an organizations internal knowledge base, and/or updated information in constructing an output, without retraining the generative AI model, e.g., the use of context database 140, described in greater detail below.

Upon receipt of a user query/conversational input from user 102, query parsing component 132 of response generation system 130 may parse the received input for intent and “key” information. That is, query parsing component 132 may break up (if needed) the user query/conversational input into tokens, and may perform stemming or other NLP-based techniques to parse the input, and as described herein, the emotion(s) associated with the parsed input can be determined. Here, key information can refer to elements of a query/input that lead to an understanding of a user's intent/context. Key information can include, e.g., keywords, named entities, and sentiment indicators, and determining key information can be determined using NLP techniques, such as tokenization, named entity recognition, part-of-speech tagging, and sentiment analysis. In this way, most relevant parts of a query/input can be extracted.

Context retrieval component 134, based on the parsed input and determined intent/key information, can access context database 140 to retrieve any relevant documents, other information, etc., (generally referred as context) relevant to the input. Context retrieval component 134, as noted above, may be a RAG-based mechanism to find relevant information from a vector database using, e.g., cosine similarity (or other like mechanism). Context database 140 may be another such vector database, and contextual documents/information that match the parsed input and intent/key information can be retrieved. The retrieval of such context provides further information relevant to the input so that a generated response is not necessarily limited to what is stated/input by user 102, thereby expanding the breadth of or enriching a generated response. For example, parsing of the query or input from user 102 may identify some mention of a particular restaurant. Context retrieval component 134 may retrieve information related to that particular restaurant, such as other restaurants in a geographical area near/about a determined location of user 102 that serve the same type of food as the restaurant mentioned in user 102's query/input, information regarding the cuisine associated with the mentioned restaurant, such as dishes that are representative of the identified cuisine, and so on.

Response generation component 136, which can be embodied as an LLM, may combine the query/input from user 102, the retrieved context produced by context retrieval component 134, and relevant memories from STM 112/LTM 114 to form a coherent response. That is, the LLM can be called with the parsed information from the query/input, RAG context obtained from context database 140, an emotional tag(s), and weighted short or long-term memories (as appropriate). Use of short and long-term memories helps ensure that a response generated by response generation component 136 is incorporates both recent and long-term relevant information. As would be understood by those skilled in the art, response generation component 136, and LLM, may typically comprise a language model based on a NN that is trained (self-supervised or semi-supervised) on a very large number of documents to perform language generation in the context of question answering, machine chatbot operations, and so on. In general, response generation component 136 can identify relationships between words in a query or input from user 102, and based on those word relationships, as well as retrieved context, emotional tags, retrieved short or long-term memories, can output a response.

Combining the query/input from user 102, the retrieved context produced by context retrieval component 134, and relevant memories from STM 112/LTM 114 to form a coherent response may comprise creating a conversational prompt that integrates such information that can be used to inform conversational system 104 how to respond to user 102. For example, an input from user 102 may be text indicating “I'm feeling down today.” This input may be tagged with an emotion, e.g., “sad.” The latest/current ten memories of user 102 can be: (1) User mentioned feeling stressed about work; (2) User enjoys painting and hiking; (3) User had a great weekend with family; (4) User is looking forward to a vacation next month; (5) User recently adopted a pet; (6) User likes reading mystery novels; (7) User is learning to cook new recipes; (8) User had a positive experience with a recent project; (9) User is planning a surprise for a friend; (10) User enjoys listening to classical music. A long-term memory (summary) may be that “user often feels better after discussing hobbies and positive experiences.” An example combined prompt can then be as follows: “You are a helpful assistant talking to a user who is feeling sad. The user said, ‘I'm feeling really down today.’ Based on the current 10 memories, the user enjoys painting, hiking, and had a great weekend with family. The user is looking forward to a vacation next month and recently adopted a pet. The user likes reading mystery novels, learning to cook new recipes, and had a positive experience with a recent project. The user is planning a surprise for a friend and enjoys listening to classical music. Previous conversations indicate the user often feels better after discussing hobbies and positive experiences. Generate a response to uplift the user.”

As would occur with human mind/memory, typically, any newly acquired knowledge, information, etc. during a conversation or interaction(s) between user 102 and conversational system 104, can be saved as a memory. Thus, memory feedback component 138 acts as a mechanism for sending such knowledge or information back to memory management system 110 to potentially be stored in STM 112, or LTM 114. That is, memory feedback component 138 may analyze the conversation (user input/generated response) thus far, and may tag aspects or portions of the conversation with an emotional context tag, while initializing memory attributes of the aspects/portions of the conversation with a timestamp and initial weight (similar to the timestamping and weighting described above). Once tagged and initialized, the aspects or portions of the conversation to be saved as a new memory(ies) can be stored in STM 112 with its embedding and metadata to ensure it remains a short term memory (e.g., as one of the last 100 memories stored in STM 112).

As noted above, examples of the disclosed technology provide systems and methods for emulating human memory, i.e., the storage and retrieval/usage of short term and long term memories. In some examples such systems and methods are implemented as an interactive chatbot, where a user engages in conversation through natural language inputs. When a user types a question or makes a comment, the interactive chatbot processes this input to generate a contextually relevant response(s). Interactions between the user and interactive chatbot can be stored in STM or LTM based on the relevance and emotional tone of such interactions.

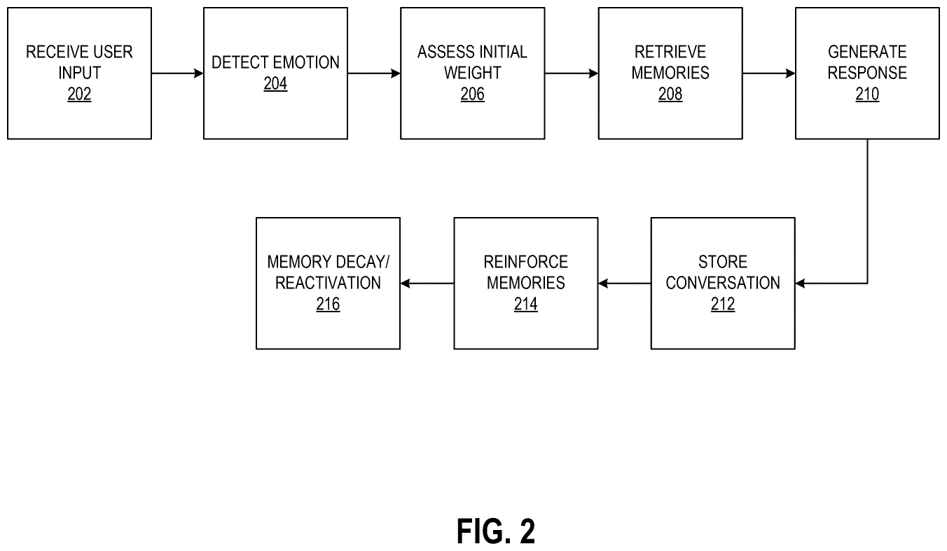

FIG. 2 illustrates an example flow chart of aspects/operations of the disclosed technology. At 202, a system, such as system 100 of FIG. 1, may receive some user input. As an example, a user may type a statement, “I'm feeling a bit frustrated about my recent project” via a UI of an interactive chatbot. The chatbot receives input in the form of text typed by the user (e.g., “I'm feeling frustrated about my recent project”). As described above, this user input can trigger memory retrieval in accordance with examples of the disclosed technology.

That is, at 204, the emotional tone of the user's input can be determined. Emotional tone, as will be described in greater detail below, can be determined by analyzing the input using either NLP methods or using an LLM. In some examples, a dominant emotion, e.g., a sensed emotion that is determined to be the predominant focus of the input, can be identified. In the above example, the term “frustrated” can be detected and determined to be the dominant emotion. For example, as noted above, an input can be analyzed and tagged with multiple emotions, if multiple emotions are determined to exist. A dominant emotion may be an emotion associated with a number of tags that exceeds the number of tags associated with another emotion, or the number of emotions deemed to be similar/related to one another exceed the number(s) of other emotions, etc. By first analyzing and determining an emotional tone of the user's input, the manner in which the chatbot retrieves memories and responds to the user input can be appropriately influenced or guided.

At 206, an initial weight may be assigned to a memory, the memory being a short term representation of one or more aspects of the user's input. For example, the textual representation of a user's input itself can be stored as a memory. Based on the detected emotion and relevance of the user's input (e.g., relevance to other stored memories associated with this conversation/interaction), the chatbot assigns an initial weight to the memory for storage. After the emotional tone is detected, an initial weight is assigned to the conversation memory reflecting how relevant or significant the memory is at the time of storage. As noted above, the factors impacting a relevance determination can include the following: the emotional tone (e.g., frustration or joy), where strong emotions increase the assigned weight, making it more likely that emotionally-charged memories will be recalled; the content's/memory's relevance to common topics or frequently discussed themes in the conversation, wherein the greater the relevance, the greater the weight assigned; and recency, which can be relative to a time of its initial creation as a memory. In this example the user's input is a current input, and its storage is recent/current, resulting in a high recency value being assigned thereto;

At 208, memories can be retrieved. As described above, retrieval/searching occurs based on the determination of context (using ANN), where memories can be filtered and ordered on the basis of emotion and weight. That is, examples of the disclosed technology may retrieve recent memories (from STM) for relevant interactions, prioritizing memories with a similar emotional tag (e.g., “frustration”). Examples of the disclosed technology may further retrieve interaction summaries from recent days, focusing on summaries that may reference work or similar topics (to “projects). As noted above, long term memories comprise summaries of previous conversations or interactions involving the user. Conversational memories, including attributes like weight, emotional tone, timestamp, and content, can be stored in STM, and based on ANN searches, the retrieval of such memories can be optimized for efficiency and relevance. Over time, memory weights decrease unless the memory is accessed frequently, simulating human memory decay. For instance, memories that haven't been accessed in a long time lose weight, decreasing their likelihood of retrieval. Thus, the forgetting of memories can be emulated by examples of the disclosed technology. However, when a memory is retrieved, the decay associated with the memory can be reset. Memories that are accessed frequently become “reactivated” and are thus less likely to decay, maintaining higher relevance over time.

At 210, a response to the user input can be generated using, e.g., an LLM, which can be called, and fed the user's input, the RAG context (obtained based on information or content retrieved from a context vector database), emotional tone, weighted memories (short term memories), and long term memories (conversational summaries). The retrieved short-term and long-term memories, along with content from the RAG-based vector database, are provided as context to the LLM alongside the user's input. The LLM can generate a response that acknowledges the user's frustration, possibly reflecting on recent work-related topics. To construct a coherent conversational exchange, in this example, the user's direct question with context retrieved STM, LTM, and the external RAG-based context vector database can be combined.

At 212, a current conversation, or aspects thereof, may be stored. Again, to emulate human memory and its storage and recollection of short and long term memories, memories are stored, where the memories may be one or more aspects of a conversation involving a user. As described herein, the conversation (or aspects thereof) can be stored in STM, where it may be prioritized for retrieval (recollection) based on its emotional alignment with, and relevance to the conversation, a particular conversational turn, etc. In some examples, the user's input, e.g., question, along with the chatbot's response can be combined to create a coherent conversational memory. Here, the operation of combining can refer to storing relevant information in a particular data structure. The emotional tone, and relevance, having been determined previously, can be stored as part of the conversational memory, along with a storage timestamp and initial weight.

At 214, memory reinforcement can be performed. That is, memories retrieved at operation 208, for example, can be re-weighted based on access frequency, and the newly generated conversation stored in STM for future retrieval.

At 216, memory decay and reactivation can be performed. Over time, the weight of stored memories decays, as described herein, unless such memories are accessed frequently enough such that the applied decay does not result in the memory eventually being “erased.” Thus, chronological jobs can be performed to update a memory's timestamp, and to increment an access count for any retrieved memories.

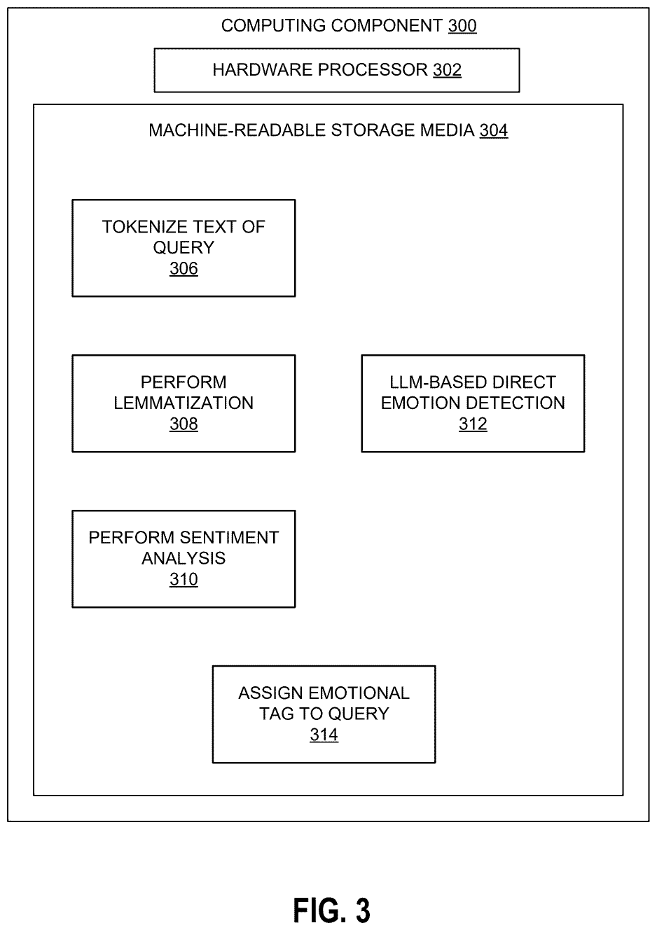

FIG. 3 illustrates a computing component that may be used to determine emotional context/emotional tone of a conversation or portion of a conversation/interaction in accordance with various examples of the disclosed technology. Computing component 300 may be, for example, a server computer, a controller, or any other similar computing component capable of processing data, e.g., such as a computing component that can perform emotion detection 204 of FIG. 2. In the example implementation of FIG. 3, the computing component 300 includes a hardware processor 302, and machine-readable storage medium 304.

Hardware processor 302 may be one or more central processing units (CPUs), semiconductor-based microprocessors, and/or other hardware devices suitable for retrieval and execution of instructions stored in machine-readable storage medium 304. Hardware processor 302 may fetch, decode, and execute instructions, such as instructions 306-314, to control processes or operations for determining emotion. As an alternative or in addition to retrieving and executing instructions, hardware processor 302 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 304, may be any electronic, magnetic, optical, or other physical storage device that contains or stores executable instructions. Thus, machine-readable storage medium 304 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 304 may be a non-transitory storage medium, where the term “non-transitory” does not encompass transitory propagating signals. As described in detail below, machine-readable storage medium 304 may be encoded with executable instructions, for example, instructions 306-314.

Hardware processor 302 may execute instruction 306 to tokenize the text or content of a query or other user input (when a user is interacting with a chatbot or conversational system). That is, text input by a user can be partitioned into individual phrases or words or other textual units (referred to as tokens). Various mechanisms or algorithms can be applied to token user input, where, e.g., whitespace can be used as a separator/delineator or words/phrases. Such tokens can then be used a vector representations of text. Thus, tokenization can be considered to be a preprocessing operation for NLP/ML tasks, allowing the user's input to be understood from, e.g., an emotional tone, and relevance standpoint. For example, text can be split into individual tokens, typically based on spaces and punctuation. For complex words, subword tokenization can be performed to break down words into smaller meaningful units. Lemmatization can be performed by processing each token to reduce the token to its base/root form (e.g., “running” becomes “run”). Thereafter, phrase identification can be performed by working backwards from the tokenized words/subwords to identify phrases and context.

Hardware processor 302 may execute instruction 308 to perform lemmatization. That is, examples of the disclosed technology may reduce words (e.g., tokens obtained by the execution of instruction 306) to their base or root form, referred to as lemma. For example, lemmatization can reduce a word/token such as a “feeling” to the lemma “feel.” Lemmatization can be performed to allow different forms of a word to be grouped so they can be analyzed or identified as a single item, or in the case of various examples of the disclosed technology, to allow the emotional tone and relevancy to be determined. It should be understood that lemmatization differs from stemming (which removes common suffixes from the end of words), where lemmatization tends to be more accurate in determining a root meaning, while stemming may be less accurate, but faster to perform.

Hardware processor 302 may execute instruction 310 to perform sentiment analysis. More particularly, an NLP model trained on sentiment and emotion detection may analyze the tokens and structures within the user's input, e.g., a sentence, to identify an emotional tone. For example, the inclusion of the word/token “frustrated” in user input can signal a negative tone.

In some examples, as an alternative to the use of NLP models/techniques to determine the emotional tone of a user's input, an LLM can be used. That is, hardware processor 302 may execute instruction 312 to perform LLM-based direct, emotion detection. For example, an LLM such as GPT-4, can be leveraged to analyze a user's input as a whole or more “holistically,” rather than tokenizing/lemmatizing. For example, an LLM, such as GPT-4, can detect nuances in user's text, such as sarcasm or complex emotions, to determine emotional tone associated with a user's input directly, without tokenization or lemmatization. In some circumstances, the use of an LLM to determine emotional tone can yield a more accurate and nuanced understanding of a user's mood. The choice between implementing emotion detection via NLP, tokenization, and lemmatization versus LLM-based emotion detection can depend on factors like project expertise, cost considerations, and timeline/performance deadlines. The flexibility in implementing an emotional detection aspect of the disclosed technology provides an ability to tailor the disclosed technology to a project's specific needs, available resources, and so on.

Hardware processor 302 may then execute instruction 314 to assign an emotional tag to a query (or other user input). Examples of the disclosed technology may use defined rules or an emotional tagging model to assign an emotional tag to a token or phrase making up a user's input. An example of an emotional tag, may be the tag “frustration,” following the above example where a user enters the sentence, “I'm feeling a bit frustrated about my recent project.” Another example of emotional tag may be more general/generic, e.g., instead of an emotional tag indicating frustration, an emotional tag may simply be a positive or negative indication. Thus, determining the existence of the word or token frustrated/frustrate, examples of the disclosed technology can tag the memory accordingly. The tag can be later used during memory retrieval (e.g., when looking for similar memories/relevant memories) and response generation.

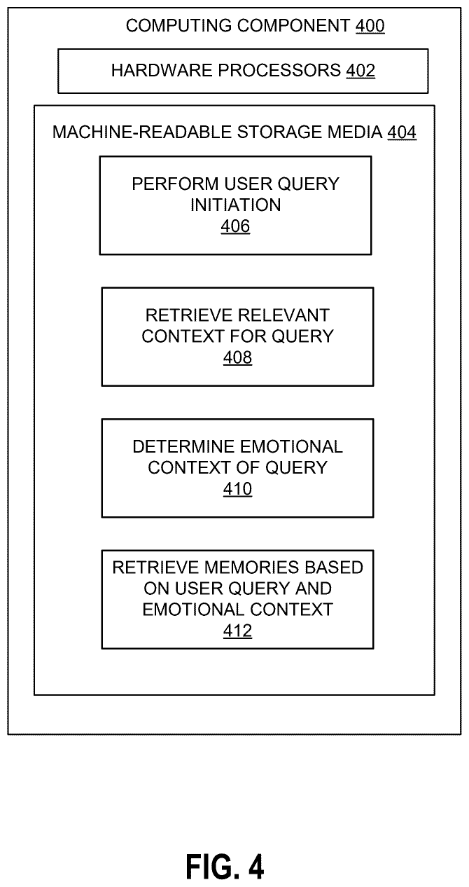

FIG. 4 illustrates a computing component that may be used to retrieve memories in accordance with various examples of the disclosed technology. Computing component 400 may be, for example, a server computer, a controller, or any other similar computing component capable of processing data, e.g., such as a computing component that can perform memory retrieval 208 of FIG. 2. In the example implementation of FIG. 4, the computing component 400 includes a hardware processor 402, and machine-readable storage medium 404. Hardware processor 402 and machine-readable storage medium 404 may be similar to hardware processor 302 and machine-readable storage medium 304, described above, respectively. Hardware processor 402 may fetch, decode, and execute instructions stored in machine-readable storage medium 404, such as instructions 406-412, to control processes or operations for retrieving memories.

Hardware processor 402 may execute instruction 406 to perform user query initiation. User query initiation can be an entry point for processing user input represented as a function, such as find_rag_interaction (user_id, user_question). Thus function can initiate the retrieval processes for context, emotion, and memories. This function further interacts with the LLM to generate a response.

As described above, in order to generate a more fulsome response to a query or other user input, examples of the disclosed technology perform context retrieval. That is, hardware processor 402 may execute instruction 408 to retrieve relevant context for the query. In some examples, a function get_matching_context_from_vector_db (user_question) can be used to search an external database, such as context database 140 (which may be a vector database) for related contextual information to enrich the query/response to the query. As described above, aspects of the disclosed technology can rely on RAG-based content, which can be effectuated by this retrieval of contextual information that is external to the conversation or interaction between the chatbot/system and user.

Hardware processor 402 may execute instruction 410 to determine the emotional context of the query. As described above, examples of the disclosed technology may analyze the emotional tone of a user's question or input to influence memory retrieval and memory weighting. An emotional context retrieval function can return a detected emotion for use, in this example, for memory retrieval. Again, determining emotional tone can be accomplished through the of a NLP, where the user query or input can be tokenized and lemmatized to discern the feeling conveyed by the user vis-à-vis the query or input.

Hardware processor 402 may execute instruction 412 to retrieve memories based on user query and emotional context. As described herein, examples of the disclosed technology leverage STM and LTM in which information gleaned in a conversation between a chatbot/conversational system and a user can be stored and accessed as if the information were short term or long term memories. That is, a function such as retrieve_memories (query, current_emotion) can be used to retrieve both short-term and long-term memories related to a user's query. This function may call other sub-functions, e.g., retrieve_relevant_memories (user_id, query_embedding, n=10) to retrieve short term memories. This function executes an ANN search in Redisearch, retrieving the top n number of relevant memories based on vector embedding similarity. As described above, a user's query or input can be vectorized making finding relevant or relatedly similar memories possible. That is, when a user query is received, an embedding (vector representation) of the query can be generated. An ANN search can then be performed, e.g., in Redisearch, to retrieve recent memories that are semantically similar to the query. Retrieved memories that match the current emotional tone of the user's query (e.g., “frustration”) can receive a slight boost in weight to prioritize emotionally-aligned memories.

Long term memory retrieval may be accomplished through the use of a sub-function retrieve_daily_summary (user_id, query_embedding, n=3). The purpose of such a long-term memory retrieval function is to obtain and return relevant, long-term daily summaries a vector database. The results of the long term memory retrieval, can in some examples, be sorted by date in descending order for most to least-recent memory insights that can be used when generating a response to the user query or input. It should be understood that a user's conversations can be summarized in accordance with a regular schedule. For example, daily conversation summaries can be generated and stored as embeddings in an LTM, e.g., LTM 114. Similar to memory retrieval from STM, e.g., STM 112, relevant daily summaries may be retrieved based on embedding similarity, recency, and relevance of a matching memory, e.g., via function retrieve_daily_summary (user_id, query_embedding, n=3). A first conversation of a day can be directly converted into a summary memory and stored, whereas if a conversation summary already exists, the existing conversation summary can be updated based on a current conversation. An LLM can be used to generate summaries, such as an LLM working with a LangChain framework or other, similar framework that have trimming and summarizing functionalities.

As noted above, the retrieval of memories from STM/LTM can be affected by the applied decay and whether or not a memory has been recently accessed (thereby reactivating that memory). That is, the memory storage timestamp can be updated, while the access count for that memory can be incremented, reducing decay, and reinforcing relevant memories. Once memories have been retrieved and used in generating a response, their respective weights may be updated based on how often those memories have been accessed. This is done to emphasize frequently-recalled memories, simulating the idea that repeated access to information strengthens the memory of that information.

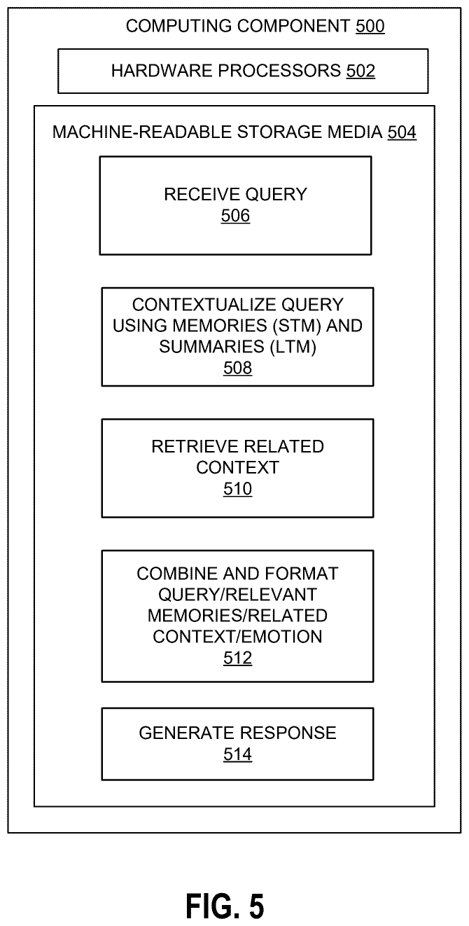

FIG. 5 illustrates a computing component that may be used to generate a response to a query or input in the context of a conversational interaction between a user and chatbot or similar conversational system in accordance with various examples of the disclosed technology. Computing component 500 may be, for example, a server computer, a controller, or any other similar computing component capable of processing data, e.g., such as a computing component that can perform response generation at 210 of FIG. 2. In the example implementation of FIG. 5, the computing component 500 includes a hardware processor 502, and machine-readable storage medium 504. Hardware processor 502 and machine-readable storage medium 504 may be similar to hardware processor 302/402 and machine-readable storage medium 304/404, described above, respectively. Hardware processor 502 may fetch, decode, and execute instructions stored in machine-readable storage medium 504, such as instructions 506-512, to control processes or operations for generating a response to a user query or input.

Hardware processor 502 may execute instruction 506 to receive a query. As explained above, a user may submit/type a query or otherwise provide some input into the UI of a conversational system, such as a chatbot. This user query or input can be used to initially set the tone/focus of a response to the user query or input. As described herein, the user query or input can be tokenized and lemmatized to allow an NLP system or function to determine the initial emotional tone of the user query or input. In some examples, the disclosed technology may use an LLM to determine the emotional tone of the user query or input.

Thus, hardware processor 502 may contextualize the query using short term and long term memories. The short and long term memories that are retrieved for this contextualization can be retrieved based on the determined, initial emotional tone of the user query or input along with weights assigned to short term memories. These retrieved items create a contextual backdrop for the language model, helping it produce responses that are more personalized and contextually accurate. For example, the ten (or other configurable number) most relevant/emotionally matching short term memories can be determined and retrieved using an ANN search. After these initial ten memories are fetched, a corresponding score can be adjusted based on how well a memory aligns with the detected emotional tone (e.g., “happy,” “sad,” “angry”). This scoring adjustment on helps to ensure that memories with a matching emotional tone are prioritized. Subsequently, the top, e.g., five, memories with the highest scores can be selected for use in/as a basis for generating a response. This approach can reflect how human memory often recalls past experiences that match our current mood. Thus, based on recent interactions, including emotional context and past questions, short term memories from STM can be retrieved, while long term memories, i.e., summaries of prior key interactions and overarching conversational themes, can be retrieved from LTM.

It should be noted that in some examples of the disclosed technology, weighting need not be limited to short term memories, i.e., weights based on recency and relevancy can also be assigned to conversational summaries that make up long term memories.

Hardware processor 502 may execute instruction 510 to perform context retrieval in accordance with examples of the disclosed technology. As described above, examples of the disclosed technology may, in part, comprise RAG-based contextualization by retrieving contextual information from a RAG-based vector database. This can be done to further enrich a conversation. By querying an external RAG-based vector database to retrieve information closely related to the user's question, a generated response can provide deeper insights, and may complement the memory-based information with the inclusion of facts, resources, or external references as additional context.

Hardware processor 502 may execute instruction 512 to combine and format the query, relevant memories, and related context and emotional tone. That is, and as described above, this information can be integrated into a singular conversational prompt.

Hardware processor 502 may execute instruction 514 to generate a response based on the singular conversational prompt. As discussed herein, an LLM can be used to generate a response that addresses the user's question, clarifies any ambiguities, (based on a user's past exchanges/conversations with the conversational system) and aligns with the user's emotional tone. By blending memory-based insights with up-to-date context from the RAG-based context vector database, the response becomes personalized, emotionally attuned, and information-rich.

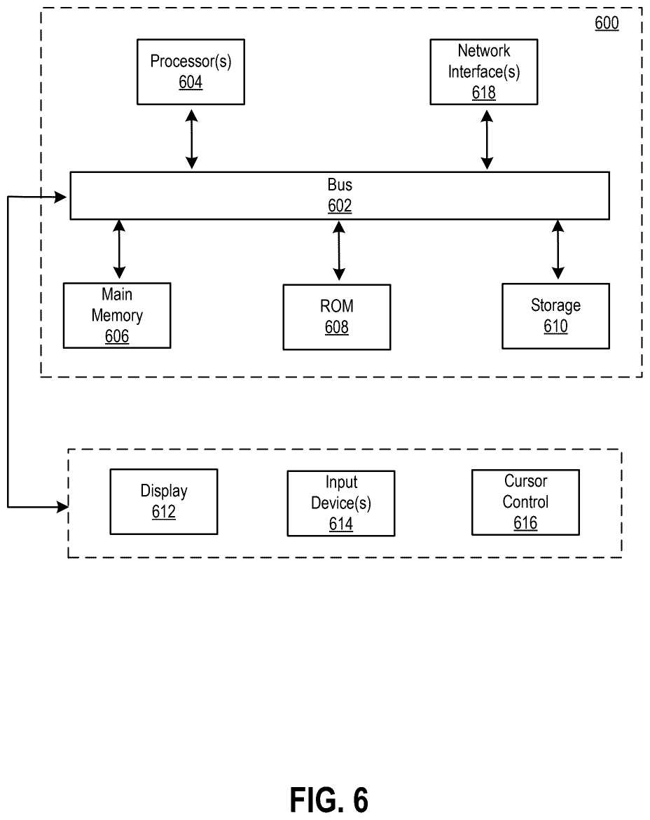

FIG. 6 depicts a block diagram of an example computer system 600 in which various examples of the disclosed technology described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions, e.g., performing human-inspired memory management (short and long term memory management) and response generation. That is, computer system 600 may be used to embody various aspects of system 100 including memory management system 110, response generation system 130, the component parts or elements thereof, and so on.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may be coupled via bus 602 to a display 612, such as a liquid crystal display (LCD) (or touch screen), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. In some examples, the same direction information and command selections as cursor control may be implemented via receiving touches on a touch screen without a cursor.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. It will be appreciated that software components may be callable from other components or from themselves, and/or may be invoked in response to detected events or interrupts.

The computer system 600 may implement the techniques described herein using customized hard-wired logic, one or more ASICs or FPGAs, firmware and/or program logic which in combination with the computer system causes or programs computer system 600 to be a special-purpose machine. According to one example of the disclosed technology, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Non-transitory media is distinct from but may be used in conjunction with transmission media. Transmission media participates in transferring information between non-transitory media.

The computer system 600 also includes a communication interface 618 coupled to bus 602. Network interface 618 provides a two-way data communication coupling to one or more network links that are connected to one or more local networks. In any such implementation, network interface 618 sends and receives electrical, electromagnetic or optical signals that carry digital data streams representing various types of information.

The computer system 600 can send messages and receive data, including program code, through the network(s), network link and communication interface 618. In the Internet example, a server might transmit a requested code for an application program through the Internet, the ISP, the local network and the communication interface 618.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS).

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A system, comprising:
a processor; and
a memory operatively connected to the processor, the memory comprising instructions, that when executed, cause the processor to:
process conversational input, and store the conversational input in a short-term memory (STM) store while storing a summarized representation of the conversational input in a long-term memory (LTM) store;
retrieve information regarding the conversational input from the STM and LTM stores according to at least one of recency and relevance of the information relative to the conversational input; and
integrate at least a subset of the retrieved information with the conversational input to generate a response to the conversational input.

2. The system of claim 1, wherein the instructions that when executed cause the processor to process the conversational input comprise instructions that when executed, further cause to processor to parse the conversational input to identify tokens or subwords.

3. The system of claim 2, wherein the instructions that when executed cause the processor to process the conversational input comprise instructions that when executed, further cause the processor to perform lemmatization to reduce the tokens or subwords to their root form.

4. The system of claim 1, wherein the memory comprises further instructions that when executed, cause the processor to determine a time that the conversational input is stored in the STM store, the time reflecting recency of the conversational input.

5. The system of claim 1, wherein the memory comprises further instructions that when executed, cause the processor to determine one or more emotional tones of the conversational input, and tag the stored conversational input with one or more emotional tags corresponding to the one or more determined emotional tones.

6. The system of claim 5, wherein the further instructions that when executed, cause the processor to determine the one or more emotional tones, comprise instructions that when executed, cause the processor to determine the one or more emotional tones on a per-conversational turn basis.

7. The system of claim 1, wherein the memory comprises further instructions that when executed, cause the processor to assign a weight to the conversational input when storing the conversational input in the STM store, the weight reflecting relevancy of the conversational input to a current conversion.

8. The system of claim 1, wherein the instructions that when executed, cause the processor to retrieve the information comprise instructions that when executed, further cause the processor to filter the information in the STM and LTM stores based on the recency and relevance of the information.

9. The system of claim 8, wherein the instructions that when executed, cause the processor to retrieve the information comprise instructions that when executed, further cause the processor to prioritize the information based on one or more emotional tags associated with the information.

10. The system of claim 1, wherein the memory comprises further instructions that when executed, cause the processor to apply a decay function to the stored conversational input and the information, the decay function decreasing or increasing a weight assigned to the stored conversational input and the information based on frequency of access of the stored conversational input and the information.

11. The system of claim 1, wherein the instructions that when executed, cause the processor to generate the response to the conversational input, comprise further instructions that when executed, cause the processor to access a context database to retrieve contextually relevant information.

12. The system of claim 1, wherein the instructions that when executed, cause the processor to generate the response to the conversational input, comprise further instructions that when executed cause the processor to further integrate the contextually relevant information with the subset of the retrieved information and the conversational input.

13. A method, comprising:
receiving, via a chatbot, a conversational input from a user interacting with the chatbot;
detecting an emotional tone of the conversational input;
assessing a weight to be assigned to the conversational input;
retrieving one or more memories from a short-term memory (STM) store and a long-term memory (LTM) store;
generating a response to the conversational input from the user based on the one or more memories and the emotional tone; and
storing a current conversation including the conversational input as additional memories in the STM and the LTM store.

14. The method of claim 13, wherein the detecting of the emotional tone comprises analyzing the conversational input by applying one of a natural language processing model on at least one of a tokenized and lemmatized version of the conversational input or a large language model on an entirety of the conversational input.

15. The method of claim 13, wherein the assessing of the weight is based on the emotional tone of the conversational input and a relevance of the conversational input to other memories stored in at least one of the LTM and STM stores that are associated with the current conversation.

16. The method of claim 13, wherein the retrieving of the one or more memories is based on prioritized filtering pursuant to the emotional tone of the conversational input, relevance to at least one of the conversational input and the current conversation, and recency of the one or more memories from the STM store.

17. The method of claim 16, further comprising reinforcing the one or more memories retrieved from the STM store by re-weighting the one or more memories based on access frequency.

18. The method of claim 17, further comprising performing memory decay and reactivation regarding the one or more memories or the additional memories by adjusting weights associated with the one or more memories or the additional memories.

19. A non-transitory medium, comprising:
instructions, that when executed by a processor, cause the processor to:
receive a query;
contextualize the query using at least one of short-term memories (STMs) stored in an STM store, and long-term memories (LTMs) stored in an LTM store, the LTMs comprising summaries of past conversations;
retrieve context related to the query;
combine and format the query, the at least one of the STMs and LTMs, the retrieved context, and emotional tone associated with the query into a singular conversational prompt;
generate a response to the query based on the singular conversational prompt.

20. The non-transitory medium of claim 19, wherein the instructions that when executed, cause the processor to contextualize the query, comprise further instructions that when executed, further cause the processor to retrieve the STMs based on weights assigned to the STMs, the retrieved STMs being prioritized based on emotional tags associated with the retrieved STMs that align with the emotional tone associated with the query.
